(19) United States
(12) Patent Application Publication
(10) Pub. No.: US 2014/0095038 A1
(43) Pub. Date: Apr. 3, 2014

(54) METHOD FOR OPERATING A SAFETY SYSTEM FOR AVOIDING COLLISIONS AND/OR FOR REDUCING THE SEVERITY OF COLLISIONS IN A MOTOR VEHICLE, AND MOTOR VEHICLE

(71) Applicants: Alexander Breu, Weiding (DE); Manfred Holzmann, Greding (DE)

(72) Inventors: Alexander Breu, Weiding (DE); Manfred Holzmann, Greding (DE)

(73) Assignee: Audi AG, 85045 Ingolstadt (DE)

(21) Appl. No.: 14/119,643

(22) PCT Filed: May 8, 2012
(86) PCT No.: PCT/EP2012/001967

§ 371 Date: Nov. 22, 2013

(30) Foreign Application Priority Data
May 25, 2011 (DE) 10 2011 102 330.9

(51) Int. Cl. B60W 30/09; B60W 10/18; B60W 10/02

(52) U.S. Cl. CPC B60W 30/09; B60W 10/02; B60W 10/18
USPC 701/67

(57) ABSTRACT

A method for operating a safety system for avoiding collisions and/or for reducing the severity of collisions in a motor vehicle that has a clutch pedal as an actuator for manually actuating a clutch. The safety system is designed to carry out at least one braking intervention when a collision is imminent. An additional actuator in form of a clutch actuator is used to automatically open and close the clutch. In the context of at least one braking intervention of the safety system, the clutch actuator is actuated in order to open the clutch dependent on at least one item of intervention information relating to the braking intervention.

The invention relates to a method for operating a safety system for avoiding collisions and/or for reducing the severity of collisions in a motor vehicle which has a clutch pedal as an actuator for manually operating a clutch, wherein the safety system is configured to perform at least one braking intervention in the event of an imminent collision, and a motor vehicle.

Longitudinally-guiding driver assistance systems capable of influencing the speed of a motor vehicle are already known in the prior art. These longitudinally-guiding systems also include safety systems for preventing a collision and/or reducing the severity of a collision, wherein the safety systems monitor the environment of the motor vehicle by way of suitable environment sensors and derive therefrom a probability for a collision. In situations with a high probability for a collision, a braking intervention is automatically carried out without driver intervention, i.e. the safety system sends a deceleration request to the brake system to brake for the potential collision object. In this case, strong temporary braking decelerations are used to significantly reduce the vehicle speed. Ideally, the safety system may operate so as to prevent an accident, but may otherwise reduce the collision speed, and thus the severity of a collision.

As a particular embodiment of such a safety system, automatic emergency braking systems for city driving have been proposed, which are active only below a certain speed threshold, e.g. below 35 km/h, and are able to reduce the speed by, for example, 20 km/hr. An intervention of the safety system is thus able to decelerate the vehicle until it comes to a standstill, where the vehicle may be held for limited, short time, of for example 1-2 seconds.

In particular in motor vehicles with a manual transmission, i.e. vehicles where the driver can manually operate the clutch via a clutch pedal and control means, the problem arises that the engine of such motor vehicles with manual transmissions typically stalls, because in these situations the driver is generally viewed as being inattentive since the safety system primarily corrects errors made by the driver while driving. The driver is not able to react fast enough in these situations so as to disengage the clutch and prevent stalling of the engine. The engine almost always stalls especially with braking interventions that lead to a standstill.

The driver must then disadvantageously basically initiate a manual restart of the engine. This is especially critical when he wants to move the motor vehicle quickly out of an accident zone or wants to avoid another potential collision object, because he now needs more time.

Stalling due to the braking action is disadvantageous for the motor vehicle for other reasons. This applies in particular to motor vehicles that are equipped with an idle speed controller for the engine. This idle speed controller increases the motor torque to counteract stalling. As a result, the engine ultimately acts against the braking intervention and the braking maneuver is thus always different depending on the engine variant and engine condition. The vehicle behavior is perceived as uncomfortable and the impression is given that the vehicle starts to “bounce”.

In addition, a reduction of the service life of vehicle components with increased incidence of such braking interventions that lead to stalling can generally not be ruled out.

When the braking interventions ends before the engine has stalled, an unexpectedly higher drive torque may be available to the driver immediately after the brake intervention due to a torque boost by the idle speed controller, which may surprise the driver.

DE 10 2005 050 043 A1 proposes a motor vehicle, which has, in addition to a clutch pedal for manual-shift transmission, an actuator operable in a reversibly activatable operating mode for automatically opening and closing the clutch without actuating the pedal. The actuator is intended for use in so-called stop-and-go situations to relieve the driver.

It is therefore an object of the invention to provide a method for operating a safety system capable of implementing a safe braking action that avoids stalling the engine and is gentle on the motor vehicle components.

The object of the invention is attained with a method of the aforementioned type in that a clutch actuator provided as an additional actuator is used for automatically opening and closing the clutch without actuating a pedal, wherein in conjunction with at least one braking intervention of the safety system the clutch actuator is controlled so as to disengage the clutch depending on at least one intervention information related to the braking intervention.

According to the invention, a motor vehicle is used, which has a basic manual-shift transmission with a clutch pedal for operating the clutch, which thus acts as one actuator. In this context, the clutch can then be opened and closed with the clutch pedal purely mechanically, for example via a Bowden cable. Independently thereof, another actuator, namely the clutch actuator, is provided which can automatically open and close the clutch, without requiring the clutch pedal to be actuated. The clutch actuator may be realized, for example, as a servo motor, and preferably acts directly on the clutch, thus for example directly on a clutch disc. Both actuators thus ultimately access the clutch in parallel, so that they are basically independent, at least with respect to opening the clutch. Even when the clutch actuator has closed the clutch, the clutch can always be opened by the driver. The driver thereby retains the basic operating authority for the clutch, so that the transmission continues to be a manual-shift transmission which, however, offers additional advantageous options in relation to a safety system.

According to the invention, in the context of at least one braking intervention of the safety system, the clutch actuator for opening the clutch is controlled depending on at least one intervention information relating to the braking intervention. The clutch is thus opened when the engine is at risk of stalling; however, this does in general not occur simply as a function of a common parameters such as the speed or the like, but rather as a function of intervention information related to the braking information. In this way, already existing background knowledge is advantageously used in the safety system to enable predictive control of the clutch actuator for disengaging the clutch. Preferably, stalling information indicating an upcoming engine stall of the motor vehicle during or directly after execution of the braking intervention can be used as intervention information, wherein the clutch is automatically opened by the clutch actuator in an impending stall. Because the environmental data and the like, as well as the strength and duration of the required braking intervention are well known from the outset, an engine stall can thus be predicted, so that it can be inferred whether the braking intervention will lead to an engine stall or a drop to a critical rotation speed range. The clutch actuator can then be controlled based on this result. This is particularly advantageous because several effects can be intercepted, which—when merely a critical speed threshold or the like would be assumed—could cause the engine to stall.

For example, the so-called “follow-up braking” should be mentioned. After the end of the braking intervention, the motor vehicle may be decelerated further, for example by 3-5 km/h. This can still cause the engine to stall, even though the actual braking intervention is not responsible. Furthermore, stalling may already have occurred before the clutch is actually opened by the clutch actuator.

Consequently, prior knowledge is used to preferably open the clutch with the clutch actuator a bit earlier, depending on the information of an impending critical rotation speed range which could cause stalling, than would occur with a standard rotation speed condition, independent of the safety system.

A number of advantages are achieved in this way. First, the motor no longer stalls even with a manual shift in spite of a braking intervention. As a result, the driver can continue driving immediately thereafter, as he wishes—possibly again aided by the safety system and the clutch actuator, as will be discussed in more detail below. There is a defined sequence for the brake engagement, which is therefore independent of the interfering variables engine and engine torque. For example, especially when the clutch is opened early, which is easily possible based on the information about possible stalling risks contained in the intervention information, an idle speed controller or the like can be prevented from attempting to counteract a stall and hence also the braking intervention by generating a higher engine torque. The braking intervention information related to the braking action can even in this regard be considered to be extremely beneficial.

By disengaging the clutch, the vehicle's power train reacts as the driver would expect with such an emergency braking, because the engine and vehicle components should be treated gently since early damaging effects such as an engine stall or even increasing the engine torque opposing a braking intervention can be counteracted. The safety system thus makes in the meantime all the correct moves while the driver is unfocused and does not correctly perceive his driving task.

When stalling information is used as intervention information, the clutch is opened only in the presence of an additional requirement, in particular an activity intervention indicating a performed braking intervention as intervention information and/or when the rotation speed of an engine falls below a threshold value. Lastly, a true-false statement (Boolean variable) related to a specific braking intervention may be used in this context as stalling information. In this case, a hard limit or an actual critical rotation speed limit should not be chosen as a threshold value for the rotation speed of the engine, but rather a rotation speed slightly above the critical rotation speed limit for stalling, thus enabling the clutch to be opened early based on the background information. With a hard criterion for stalling represented by, for example, a rotation speed limit of 900 RPM, the threshold value for the rotation speed could in this context be set to, for example, a value of 1200 RPM.

In a specific embodiment, the condition for beginning to open the clutch with the clutch actuator can be defined by checking whether an automatic braking intervention is currently present and whether the engine rotation speed is less than the threshold value for the rotation speed (applicable overspeed protection threshold), and whether the stalling information indicates an upcoming stall. When all these conditions are present, the clutch is disengaged (opening operation of the clutch).

To determine the stalling information, the level and/or the duration of the intervention, the stalling information can be predicted based on environmental data of the motor vehicle and host (own) data of the motor vehicle, wherefrom the stalling information can be by determining a final rotation speed to which the engine is decelerated and through a comparison with a critical rotation speed limit. The rotation limit speed mentioned here is smaller than the threshold value for the rotation speed within the context of the additional condition. Because the environment is identified, the safety system can thus predict the level and duration of the intervention and deduce therefrom whether the braking process will cause the engine to stall or whether the rotation speed will drop to a critical rotation speed range below the rotation speed limit. For example, when the safety system detects that only a short braking intervention is necessary and no stalling risk for the engine exists, or that no critical rotation speed ranges are reached, the stalling information indicates that stalling of the engine is not imminent, and the clutch remains closed.

As already mentioned, it is especially advantageous within the context of the invention, when the driver is also supported upon restart after a braking intervention, i.e. when the driver advantageously has enough time and available mechanisms to take over control of the vehicle as usual. Therefore, in a particularly advantageous embodiment of the present invention, the clutch may be automatically closed by the clutch actuator after the clutch was automatically opened by the clutch actuator due to a braking intervention, especially based on at least one control information. It should be noted at this point that the closing operation is in principle considered to be completed no later than when the clutch is again fully closed. The clutch actuator may also be used to continue to assist the driver following the braking intervention or even to “artificially” force the engine to stall.

Advantageously, when the motor vehicle does not come to a standstill immediately after the braking intervention, the closing operation is performed immediately following the braking intervention, and when a braking intervention leads to a complete stop, the closing operation is started after a predetermined idle period, in particular 0.8-1.2 s. The relatively short time during which the motor vehicle is kept at a standstill, preferably 1 s, has been shown based on studies to be particularly advantageous to alert the driver again to the driving situation by the surprising braking intervention, so that the driver is dedicated to the driving task, i.e. is again “in the loop”. This attention phase of the driver must be used to transfer as soon as possible the driving responsibility again to the driver, i.e. to take over driving, which it is clearly indicated by the closing operation.

Particularly advantageously, the closing operation is in its concrete embodiment made dependent on the control information which ultimately describes how the driver reacts and gives an indication of his wishes. In this case, different scenarios for controlling the motor vehicle, in particular the pedals, should be observed which can all be implemented in a particularly advantageous manner.

Accordingly, when the control information indicates that the driver operates neither a brake pedal nor an accelerator pedal, the clutch is automatically closed again during a first clutch engagement duration. Therefore, when disengagement with the clutch actuator has occurred as a result of a braking intervention, a braking intervention that does not result in a standstill is prevented, or the standstill time has ended and the control information also indicates that the driver has operated neither the accelerator pedal nor the brake pedal, then the system begins very slowly, specifically during the first clutch engagement duration, to engage the clutch again via the clutch actuator, thereby causing the motor vehicle to start to move slowly forward and to thus indicate to the driver that he needs to take again control of the vehicle. Even when the driver does not react, reengaging (closing) the clutch continues and can subsequently lead to an engine stall. This is allowed here because it ultimately corresponds to a intent of the driver—namely not to react. This also applies when the driver operates the brake pedal during this phase. Then no further disengagement occurs, and the closing operation is used instead, which can also lead to an engine stall because the driver causes this by his own braking request However, when the driver operates the accelerator pedal, the procedure described below can instead be applied in a particularly advantageous manner.

For example, according to the invention, with control information indicative of an actuated accelerator pedal, in particular also during an ongoing closing operation, the closing operation is implemented as a startup process by closing the clutch during a second clutch engagement duration, which in particular corresponds to the first clutch engagement duration. It is then not only checked whether the braking intervention that did not resulting in a standstill or the standstill time has ended, and whether a disengaged state is present that was caused by the clutch actuator in conjunction with a braking intervention, but also whether an active closure operation may be in progress. When the control information further indicates that the driver operates the accelerator pedal, the safety system starts again to engage the clutch via the clutch actuator. A startup with a slipping clutch is realized, definitely causing the vehicle to move forward. The second clutch engagement duration required to again completely close the clutch can thereby correspond to the first clutch engagement duration, wherein it is understood that an already elapsed portion of the first clutch engagement duration can form a part of the second clutch engagement duration upon actuation of the accelerator pedal during a closing operation.

In this context, a desired drive torque requested by operating the accelerator pedal may be limited and/or reduced as a function of at least one constraint criterion. This means that excessive torque settings by the accelerator pedal are abated through a torque reduction or torque limitation in order to reduce excessively high clutch slip torques. This produces a defined startup which, on one hand, ensures a speedy startup, but at the same time not an exceedingly dynamic startup, so as not to frighten the driver if the driver is not aware of his current position on the accelerator pedal, for example, when the driver is surprised by the braking intervention and is pushed against the accelerator pedal or the like. In particular, a time-dependent curve may be used to describe a permitted maximum torque during the second clutch engagement duration, wherein a higher torque becomes available with increasing time of the closing operation. For example, the curve may include at least one ramp, particularly two ramps, which slowly permit a faster acceleration. These ramps may also be viewed as two signs. It may take here, for example about 4-6 s, preferably 5 s, until the desired drive torque actually indicated by the accelerator position is attained. An initial limitation may, for example, be selected so as to be located approximately 50-60 Nm above the idling torque; however, this ultimately depends on the specific vehicle and the actual idling torque.

It should generally be noted that many motor vehicles already have suitable sensors for verifying the position of the various pedals. The measurement of pedal positions and pedal actuations is largely known in the art and will therefore not be discussed further here. However, such information can advantageously be used in particular within the context of the startup operation to further clarify the control information with respect to the driver's wishes.

Moreover, an actuation signal describing the actuation of the accelerator pedal may be determined, wherein when the actuation signal indicates that the driver is oversteering, the closing operation is completed during a third clutch engagement duration that is shorter than the second clutch engagement duration and the process of limiting and/or reducing the desired drive torque according to the third clutch engagement duration is eliminated more quickly. An oversteering behavior by the driver includes, for example, so-called “pumping” of the accelerator pedal as well as an for example rapid, full depression of the accelerator pedal, which both indicate that the driver intends to move his motor vehicle very quickly away from the current position, for example because a different possible collision object approaches or the like. Such oversteering behavior can be determined from a zero position of the pedal and/or from amplitude values in conjunction with accelerator pedal gradients, meaning that data from a sensor measuring actuation of the accelerator pedal are evaluated using different criteria to determine the actuation information. If oversteering is detected, the startup of the vehicle is accelerated in that the clutch actuator closes the clutch more rapidly and the limitation via the torque reduction is eliminated faster, for example in stages. Thus, the entire process is accelerated, so that the motor vehicle can be moved faster away from its current position.

According to another embodiment of the present invention, with actuation information indicating actuation of a brake pedal, in particular also during an ongoing closing operation, the clutch is kept open from the start of brake pedal actuation or, when a standstill time exists, after the termination of the braking intervention with the brake pedal already actuated, upon termination of the braking intervention and expiration of the idle time for a certain wait time, in particular 1 to 3 seconds, before the clutch is closed with a fourth clutch engagement duration that, in particular, corresponds to the first clutch engagement duration. Upon actuation of the brake pedal, the disengaged state is still maintained via the clutch actuator for a predetermined time period, the wait time, which can be for example two seconds. Only then begins a slow closing operation which can subsequently lead to an engine stall unless the driver takes over accordingly. It should be noted that, when the driver depresses the accelerator pedal during this process, the aforedescribed procedure can be selected for the startup. The delay time thus gives the driver an opportunity to first orient himself.

The influence of the safety system also during an ongoing closing operation ensures that the concept of correcting everything for the driver, as long as he is unfocused and does not correctly perform his driving task, may advantageously be expanded until the driver has again taken control of the vehicle or an engine stall has occurred. The driver is thus, as already mentioned, provided with enough time and mechanisms so as to take normal control of the vehicle.

Advantageously, an ongoing opening and/or closing operation of the clutch may be terminated in response to a signal indicative of an actuation of the clutch pedal. This means that any opening or closing operation is essentially terminated by the clutch actuator in the operation of the safety system as soon as the driver himself actuates the clutch via the clutch pedal. This indicates that the driver is basically ready to take over driving. Even when a clutch has been opened by the clutch actuator and the clutch pedal has been actuated, the clutch actuator can preferably very quickly close the clutch with the clutch actuator, meaning that the clutch is no longer held open by the clutch actuator, but may be held open by the clutch pedal.

Preferably, a request to the driver to assume control is outputted by an audible or visual output means during an opening operation and/or when a clutch is automatically opened by the clutch actuator and/or during a closing operation. In other words, the driver is informed by optical and acoustic measures, such as a combination instrument, and takes over driving during the entire duration of the opening operation, the closing operation or when a clutch has been opened by the clutch actuator in a brake intervention. In this example, special acoustic or visual output means, such as symbols, associated with the added functionality of the present method may be provided to indicate an automatically opened clutch, a closing operation, and the like. This ensures optimal information for the driver.

Advantageously, a clutch opened by the clutch actuator may also be automatically closed when the motor vehicle is in a fault state. Accordingly, a fail-safe state is defined, which closes the clutch again when the clutch has been opened by the clutch actuator and in the presence of unillustrated system states and fault states. Consequently, a speedy closing operation is always initiated during fault states or other undefined system states. This is useful, for example, when the motor vehicle breaks down or the like, because the vehicle would not be movable if the clutch would always be kept open by the clutch actuator. Therefore, the clutch should always be closed in ambiguous situations, but can still be opened and closed as usual via the clutch pedal.

Besides the method, the present invention also relates to a motor vehicle, including a clutch pedal as an actuator for manually operating a clutch, a clutch actuator as an additional actuator for the clutch for automatically opening and closing the clutch, and a safety system for collision avoidance and/or for reducing the severity of a collision, with a controller configured to perform a method according to one of the preceding claims. The controller of the safety system is thus configured to—in conjunction with a braking intervention of the safety system—control or initiate control of the clutch actuator so as to open the clutch in response to at least one intervention information related to the braking intervention. All statements with respect to the inventive method can likewise be applied to the motor vehicle according to the invention, so that the described advantages can also be achieved with the motor vehicle.

Further advantages and details of the present invention will become apparent from the exemplary embodiments described hereinafter and from the drawings, which show in:

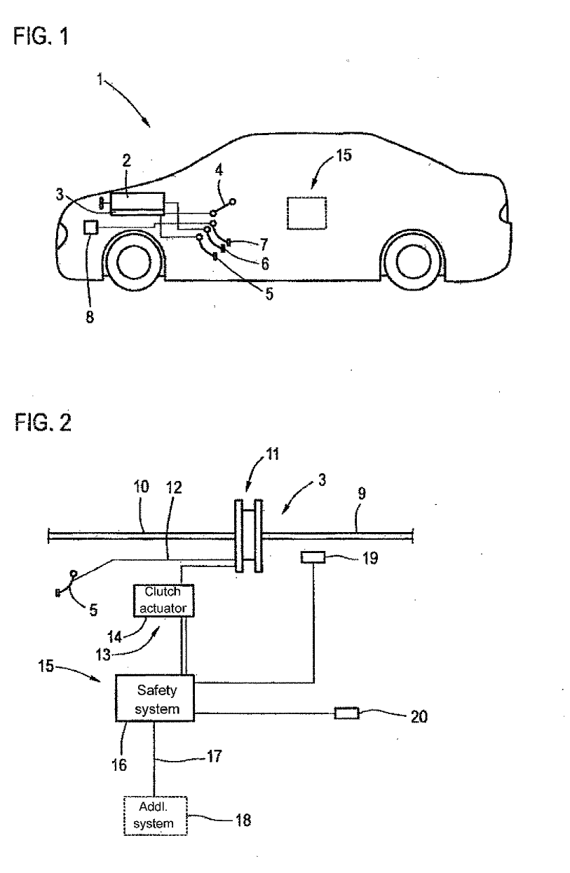

FIG. 1 a motor vehicle according to the present invention,

FIG. 2 a schematic diagram of the relevant elements for the method of the motor vehicle of FIG. 1,

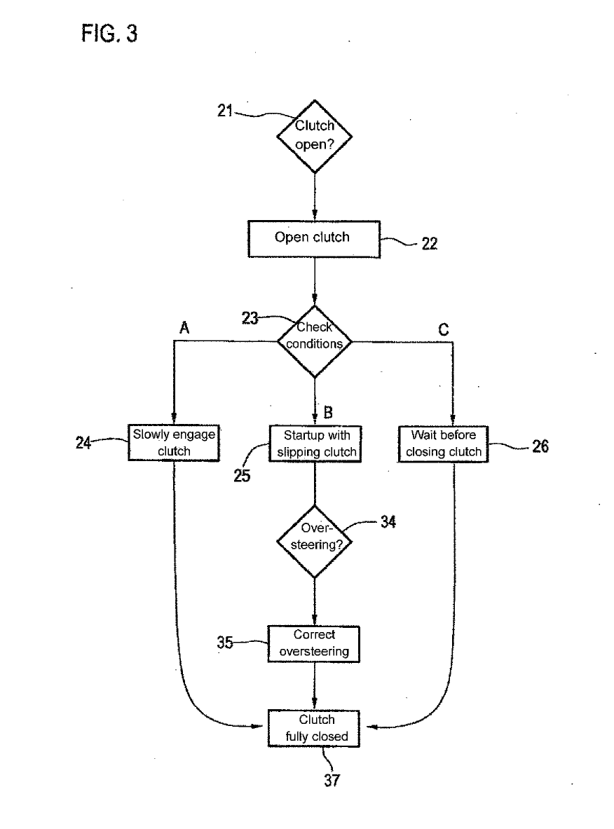

FIG. 3 a flowchart of the method according to the present invention, and

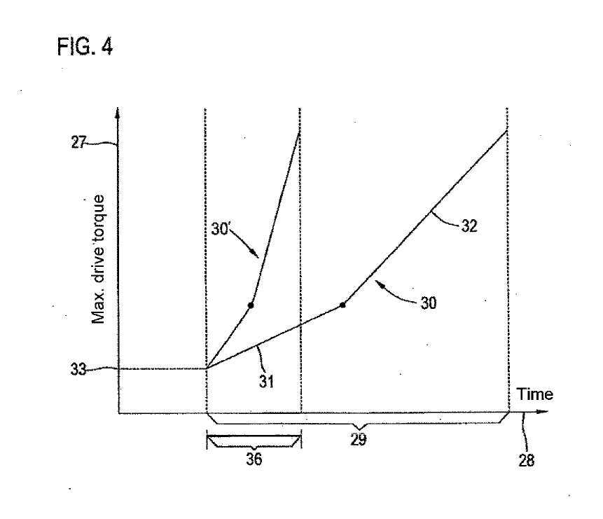

FIG. 4 a possible curve for limiting the desired drive torque.

FIG. 1 shows a schematic diagram of a motor vehicle according to the invention 1, which includes an engine 2 and a transmission 3, which can be manually shifted by the driver via a shift lever 4, to which end the transmission must be disengaged. This is accomplished, as is generally known, with a clutch pedal 5, which must be actively moved by the driver for opening or closing the clutch.

Furthermore, an accelerator pedal 6 is provided, which regulates the supply of fuel and thus transmits a desired drive torque to the engine 2. Lastly, a brake pedal 7 is provided, which actuates the brakes of a braking system 8 in a known manner.

FIG. 2 shows essential components of the motor vehicle 1 in form of a schematic diagram. Shown is the transmission 3 having a transmission input shaft 9 and a crankshaft 10 which can be reversibly coupled with and uncoupled from each other via a clutch 11. This is accomplished, as already described, on one hand with the clutch pedal 5 which is to be actively operated by the driver. When the clutch pedal 5 is depressed, the clutch 11 is known to open, whereas when the clutch pedal 5 is again released, the clutch 11 is closed. The clutch pedal 5 therefore represents an actuator, which in the present embodiment acts purely mechanically on the clutch 11, in particular, by way of a Bowden cable 12 which engages directly on the clutch and is only schematically indicated in FIG. 2.

In addition, an additional actuator 13, namely a clutch actuator 14, is now provided which can be constructed as a servomotor and which is preferably arranged directly in the transmission 3. The clutch actuator 14 can then also operate directly on the clutch—in parallel with the Bowden cable 12. However, other embodiments of the actuator are also feasible.

The motor vehicle 1 further includes a safety system 15 schematically indicated in FIG. 1 for collision avoidance and/or reducing the severity of a collision, which includes a controller 16 for controlling the clutch actuator 14. The controller 16 is configured to perform the method according to the invention, i.e. to control in a braking intervention the clutch actuator 14 for opening the clutch 11 in response to at least one intervention information relating to the braking intervention. The safety system 15 is connected with additional vehicle systems 18 via a schematically indicated vehicle bus 17, from which various information can be obtained, in particular environmental data, or to which requests may be outputted, for example during a brake intervention a deceleration request to the braking system 8 representing an additional vehicle system 18.

Rotation speed information is transmitted to the controller 16 via a rotation speed sensor 19, which in the illustrated example picks up the rotation speed at the transmission input shaft 6. The controller 16 is also connected to display means 20, including optical and acoustic display means, which can be used to output various information about the operation of the safety system 15 for the driver and in particular information to take over driving. The display means may also be used by other vehicle systems.

The safety system 15 is in the present example an automatic emergency braking system for metropolitan operation. The safety system 15 receives via the vehicle bus 17 environment data which can be used to determine a collision probability for different objects. Warnings can be issued based on certain thresholds for the collision probability; however, a braking intervention can also be performed in order to brake the host vehicle 1 ahead of a collision and/or to reduce the severity of a collision by reducing the collision speed. Because the present example involves an automatic emergency braking system for city driving, it is active only below a certain limit speed, here 35 km/h. The speed is provided by suitable other vehicle systems 18.

The overall functionality of such safety systems is already known in the art and will therefore not be described in detail.

As mentioned above, the controller 16 is configured to perform the inventive method and serves the purpose to use information already known to the safety system 15 via the braking intervention so as to prevent through an early intervention an engine stall or other negative effects on the various systems of the motor vehicle.

To this end, FIG. 3 shows a basic flowchart of the method according to the invention, which is performed during and immediately after a braking intervention.

At step 21, it is continuously checked whether the conditions for an opening operation of the clutch 11 by the clutch actuator 14 are satisfied. The intervention information is also taken into account here, as already mentioned.

The intervention information relates here to stalling information indicating an impending stall of the engine 2 of the motor vehicle 1 during or immediately after completion of the braking action, wherein data of the safety system 15 itself can be used to determine the stalling information. The controller 16 then predicts, based on the observation of the environment, i.e. the environment data, the severity of the intervention and duration of the intervention. Therefrom it can be deduced whether the braking operation will cause the engine to stall or until a critical speed range is reached. Specifically, for example, it can be examined whether a final rotation speed that is reached after the braking intervention is concluded falls below a critical rotation speed limit, in which case an upcoming stall is detected. A corresponding variable—the stalling information—is set to the value “true.” However, when for example only a short braking intervention is necessary without the risk of an engine stall and where no critical rotation speed ranges are reached, the variable is set to “false.”

In addition to the condition of a predicted stall of the engine 2, additional conditions are still considered, which must also both be present, namely activity information indicative of performing a braking intervention as well as the rotation speed of the engine 2 dropping below a threshold value. An applicable rotation speed protection threshold is chosen, which is above the critical rotation speed limit so as to be able to open the clutch as early as possible and to perform a defined braking intervention even when an idle speed controller is present, which could apply a torque boost to counteract, for example, the braking operation.

Thus, when a stall of the engine 2 was predicted and the two additional conditions are also present, as well as when the clutch 11 is opened by the clutch actuator 14, at a step 22, an opening operation that is controlled by the controller 16 accordingly.

However, the method according to the invention also supports the restart operation following a braking intervention, by closing the clutch 11 with the clutch actuator 14 based on certain conditions, wherein the closing operation ends at the latest when the clutch 11 is again completely closed. This closing operation can be performed immediately following a braking intervention that did not cause the vehicle to come to a complete stop, and can begin following a predetermined standstill time, here one second after a braking intervention that caused the vehicle to come to a complete stop. This already defines a basic condition necessary for performing the closing operation. In the concrete implementation of the closing operation, however, other criteria depending on control information are taken into account. Consequently, it is checked at step 23, which conditions are present and how closing of the clutch 11 should actually be performed.

It should already be noted here that within the context of the method of the invention, it is monitored, whenever an opening operation or a closing operation are performed or when the clutch 11 is in an open state caused by the clutch actuator 14, whether the driver depresses the clutch pedal 5. If the clutch pedal 5 is depressed, an opening operation or a closing operation is immediately terminated and the clutch actuator is moved to a position corresponding to a completely closed clutch. This means that an actuation of the clutch pedal 5 is always interpreted as an intent of the driver to again completely take over driving the vehicle, such that the clutch pedal 5 has always priority over the clutch actuator 14.

The other control information concerns here the pedal actuation and can be supplied by suitable, commonly known sensors and measuring devices.

A first potentially present overall condition A for a closing operation includes, in addition to the basic condition, the query whether a clutch 11 was automatically opened by the clutch actuator 14, as well as the condition when evaluating the control information that neither the accelerator pedal 6 nor the brake pedal 7 are operated. If this overall condition A is present, then the safety system 15 engages at a step 24 very slowly via the clutch actuator 14 during a first engagement time duration, so that the motor vehicle 1 begins to slowly move forward, indicating to the driver that he again must take control of the vehicle. No change takes place when the driver depresses the brake pedal 7 during the closing operation at step 24, even though this leads to stalling the engine 2, because this is then caused by the driver's own braking request.

It should be noted here that it is continuously checked during the closing operation at step 23, whether a condition exists for switching between the different procedures at steps 24, 25 and 26, for example when the driver depresses the accelerator pedal 6 during the closing operation at step 24, whether the condition B which will be explained below is satisfied, and therefore step 25 is continued.

The overall condition B includes, in addition to the basic condition, initially the query whether a clutch 11 has been opened automatically by the clutch actuator 14 or whether a closing operation is currently active. Furthermore, the control information must show that the driver actuates the accelerator pedal 6.

The closing operation is then performed according to step 26. Here, the safety system 15 also starts to again engage the clutch 11 via the clutch actuator 14, meaning that a startup with a slipping clutch 11 is realized, wherein however excessive torque demands via the accelerator pedal 6 are mitigated by a torque limitation. The closing operation takes place during a second clutch engagement duration which may correspond to the first clutch engagement duration.

The torque limitation is carried out by providing only a slowly rising maximum drive torque described by a curve, as shown for example in FIG. 4. The maximum drive torque is here plotted on an axis 27 as a function of time (axis 28), on which the second clutch engagement duration 29 is marked. The curve 30 includes here two ramps 31, 32 with different slopes, which represent an upper limit of the desired drive torque. In the present example, the curve starts at a starting drive torque 33, which is about 50 to 60 Nm above the idle torque. This torque is then slowly increased, as indicated.

Because situations may arise where a driver must move the vehicle 1 more quickly to a new location following a braking intervention, an actuation signal describing the operating mode of the accelerator pedal 6 is continuously determined at a step 34 and checked as to whether this signal indicates oversteering by the driver. This may mean, for example, that the driver indicates by “pumping”, i.e. by repeatedly depressing and releasing the accelerator pedal 6, or by rapidly and fully depressing the accelerator pedal 6, that he intends to move the vehicle quickly away, for example, because another collision object approaches. When such oversteering behavior occurs, this behavior is modified during the closing operation at a step 35 such that the overall process is accelerated. In other words, the clutch already engages during a shorter clutch engagement duration 36 also illustrated in FIG. 4, whereby the torque limitation is also eliminated more quickly, as shown by the curve 30′. The limitation of the drive torque, however, can also be eliminated in stages.

Finally, there is an overall condition C, where it is checked in addition to the basic conditions whether an open clutch 11 has actually been opened by the clutch actuator 14 or whether a closing operation is currently performed, and further, whether the control information indicates that the driver currently actuates the brake pedal 7. As a consequence, at step 26, the clutch 11 is initially kept open due to the brake pedal actuation for a wait time of, in the present example, two seconds prior to being closed during a fourth clutch engagement duration that corresponds here to the first clutch engagement duration. If the accelerator pedal 6 is then still operated during the closing operation, then the overall condition B is satisfied and the process can proceed to step 25.

In any case, the closing operation is completed and the clutch is completely closed with the clutch actuator 14 when the clutch pedal 5 is operated or the clutch 11 is again fully closed, step 37.

Throughout the entire duration of the opening operation, of the closing operation and also when the clutch was opened with the clutch actuator 14, the driver is informed via the visual and acoustic indicator means 20 and asked to take over driving. In this case, for example backlit symbols may be provided informing the driver of the automatic disengagement, for example a symbol that is back-lit when automatic disengagement with the clutch actuator 14 has occurred and begins to flash as soon as the closing operation begins. However, other possibilities for informing the driver are also conceivable.

Finally, it should be noted that whenever the clutch 11 is held open by the clutch actuator 14 and a fault condition or an undefined system state is detected, a speedy closing operation is initiated, because a restart would otherwise be prevented if after a clutch 11 were held open by the clutch actuator 14. Consequently, a fail-safe state is hereby assumed.

1.-15. (canceled)

16. A method of operating a safety system for at least one of avoiding a collision and reducing a severity of a collision in a motor vehicle, wherein the motor vehicle comprises an actuator constructed as a clutch pedal for manually operating a clutch and a clutch actuator constructed as an additional actuator for automatically opening and closing the clutch, said method comprising:
with the safety system, performing at least one braking intervention when a collision is imminent, and
in conjunction with the at least one braking intervention, controlling the clutch actuator so as to open the clutch in response to at least one intervention information relating to the at least one braking intervention.

17. The method of claim 16, wherein the at least one intervention information comprises stalling information indicating an impending stall of an engine of the motor vehicle during or immediately following the at least one braking intervention, the method further comprising automatically opening the clutch with the clutch actuator in the impending stall.

18. The method of claim 17, further comprising checking for presence of an additional condition in form of activity information indicating that a braking intervention is performed, and opening the clutch when the additional condition is present.

19. The method of claim 17, further comprising checking for presence of an additional condition indicating that a rotation speed of the engine is falling below a threshold value, and opening the clutch when the additional condition is present.

20. The method of claim 17, further comprising predicting a strength or a duration, or both, of the braking intervention based on environmental data of the motor vehicle and on host data of the motor vehicle, determining the stalling information from a final rotation speed for deceleration, and comparing the final rotation speed with a critical rotation speed limit.

21. The method of claim 16, wherein the clutch is automatically closed again by the clutch actuator, after the clutch was automatically opened by the clutch actuator during the at least one braking intervention.

22. The method of claim 21, wherein the clutch is automatically closed again by taking into account at least one control information.

23. The method of claim 21, wherein the clutch is closed immediately after the at least one braking intervention when the motor vehicle is not completely stopped by the at least one braking intervention, whereas the clutch begins to close following a predetermined standstill time, when the motor vehicle was completely stopped by the at least one braking intervention.

24. The method of claim 23, wherein the predetermined standstill time is between 0.8 and 1.2 s.

25. The method of claim 22, wherein the clutch is automatically closed during a first clutch engagement duration when the at least one control information indicates that a driver operates neither a brake pedal nor an accelerator pedal.

26. The method of claim 25, wherein when the at least one control information indicates that the accelerator pedal is actuated while the clutch is being closed, closing the clutch during a second clutch engagement duration causes the vehicle to start up, wherein the second clutch engagement duration corresponds to the first clutch engagement duration.

27. The method of claim 26, wherein a desired drive torque requested by actuation of the accelerator pedal is limited or reduced, or both, as a function of at least one limitation criterion.

28. The method of claim 27, further comprising determining an actuation signal describing a type of actuation of the accelerator pedal, when the actuation signal indicates oversteering behavior by the driver, terminating closing of the clutch during a third clutch engagement duration that is shorter than the second clutch engagement duration, and eliminating the limitation or reduction of the desired drive torque more quickly commensurate with the third clutch engagement duration.

29. The method of claim 25, wherein when the at least one control information indicates that the brake pedal is actuated while the clutch is being closed, the clutch is held open from a start of the brake pedal actuation or, when the brake pedal was already actuated after completion of the at least one braking intervention or after a standstill time, during a wait time, before the clutch is closed during a fourth clutch engagement duration that corresponds to the first clutch engagement duration.

30. The method of claim 29, wherein the wait time is between 1 and 3 seconds.

31. The method of claim 16, wherein an ongoing opening operation or closing operation of the clutch is terminated in response to a signal indicating actuation of the clutch pedal.

32. The method of claim 16, further comprising, when the clutch is being opened or closed or when the clutch is automatically opened by the clutch actuator, sending from an output device an audible or visual signal to the driver with a request that the driver takes over driving.

33. The method of claim 16, further comprising automatically closing the clutch that was previously opened by the clutch actuator, when the motor vehicle is in a fault state.

34. A motor vehicle, comprising:
a clutch,
a clutch pedal constructed as an actuator for manually operating the clutch,
a clutch actuator constructed as an additional actuator for automatically opening and closing the clutch, and
a safety system for at least one of avoiding a collision and reducing a severity of a collision, said safety system comprising a controller configured to perform with the safety system at least one braking intervention when a collision is imminent, and in conjunction with the at least one braking intervention, control the clutch actuator so as to open the clutch in response to at least one intervention information relating to the at least one braking intervention.
